(19) United States
(12) Patent Application Publication
(10) Pub. No.: US 2025/0100532 A1
(43) Pub. Date: Mar. 27, 2025

(54) METHOD AND DEVICE FOR OPERATING AN ELECTROMECHANICAL WHEEL BRAKE UNIT, ELECTROMECHANICAL WHEEL BRAKE UNIT AND BRAKE SYSTEM

(71) Applicant: Robert Bosch GmbH, Stuttgart (DE)

(72) Inventors: Andrej Gardt, Abstatt (DE); Dietmar Kratzer, Tamm (DE); Mark Boehm, Lehrensteinsfeld (DE); Martin Winkler, Sonthofen (DE)

(21) Appl. No.: 18/802,197

(22) Filed: Aug. 13, 2024

(30) Foreign Application Priority Data
Sep. 21, 2023 (DE) 10 2023 209 215.8

(51) Int. Cl. B60T 17/22; B60T 13/74; F16D 65/18; F16D 66/00; F16D 66/02; F16D 121/24

(52) U.S. Cl. CPC B60T 17/22; F16D 66/027; B60T 13/746; F16D 65/18; F16D 2066/003; F16D 2066/006; F16D 2121/24

(57) ABSTRACT

A method for ascertaining a wear value of an electromechanical wheel brake unit for a motor vehicle. The wheel brake unit includes a displaceable actuator element which is movable by a controllable actuator against a brake disk to generate a braking force. The actuator includes an electric motor with a rotor rotatably mounted and operatively connected to the actuator element. In the method, depending on the displacement of the actuator element, the wear value of the wheel brake unit is determined. For ascertaining the wear value, the actuator element is first displaced against an end stop. The actuator element is subsequently moved against the brake disk. When the actuator element is moved from the end stop against the brake disk, the number of revolutions of the rotor is monitored. Depending on the sensed number of revolutions, the wear value of the wheel brake unit is ascertained.

### CROSS REFERENCE

The present application claims the benefit under 35 U.S.C. § 119 of German Patent Application No. DE 10 2023 209 215.8 filed on Sep. 21, 2023, which is expressly incorporated herein by reference in its entirety.

### FIELD

The present invention relates to a method for ascertaining a wear value of an electromechanical wheel brake unit for a motor vehicle, wherein the wheel brake unit comprises a displaceable actuator element, which is movable by a controllable actuator against a brake disk of the wheel brake unit in order to generate a braking force, wherein the actuator comprises an electric motor with a rotor rotatably mounted and operatively connected to the actuator element, wherein the wear value of the wheel brake unit is determined depending on the displacement.

Furthermore, the present invention relates to a device for carrying out the method described above, to an electromechanical wheel brake unit with such a device, and to a brake system comprising at least one electromechanical wheel brake unit.

### BACKGROUND INFORMATION

Methods of the type mentioned at the outset are described in the related art. For example, European patent No. EP 3 908 490 B1 describes a method for operating an electromechanical wheel brake unit, in which method an actuator element is displaced to a first end position, at which the wheel brake unit is in a non-stressed state, and is displaced from there to a second end position, in which the actuator element is pressed against a brake disk in order to generate a braking force. A rotor position and/or a motor current of an electric motor of the wheel brake unit is continuously monitored in order to determine an air gap or a degree of pad wear depending on the ascertained contact position at which the actuator element has impinged on the brake disk.

### SUMMARY

A method according to the present invention with certain features of the present invention may have the advantage that continuous monitoring of the current position of the actuator element can be dispensed with and an absolute movement path of the actuator element can be ascertained, which always has the same starting point. According to an example embodiment of the present invention, it is provided for this purpose that, for ascertaining the wear value, the actuator element is first displaced against an end stop, the actuator element is subsequently moved against the brake disks, and that, when the actuator element is moved from the end stop against the brake disk, the number of revolutions of the rotor is monitored and, depending on the sensed number of revolutions, the wear value of the wheel brake unit is ascertained. The present invention thus provides that the actuator does not move the actuator element from a rest position, which is somehow spaced apart from the brake disk, toward the brake disks but that the actuator always moves the actuator element starting from an end stop, which positively defines a start position of the actuator element, toward the brake disk. In the process, the end stop expediently interacts with the actuator element in the movement direction of the actuator element that faces away from the brake disks, so that the actuator element is pulled back against the end stop and moved forward against the brake disks. The defined end stop ensures that the movement of the actuator element always takes place starting from the same start position and that an absolute movement path of the actuator element and/or wear value or degree of wear of the wheel brake unit is thus ascertained. As a result of monitoring the number of revolutions of the rotor, complex rotor position monitoring, as performed in the related art, is also dispensed with. Due to the end stop, a large distance of the end stop and thus of the start position to the brake disks is ensured in comparison to the related art, whereby the use and evaluation of a number of revolutions is advantageously made possible.

According to a preferred development of the present invention, a speed sensor is assigned to the rotor, wherein the number of revolutions is sensed by means of the speed sensor. This creates a cost-effective solution because, for example, a speed sensor already assigned to the electric motor can be used.

Furthermore, it is preferably provided according to an example embodiment of the present invention that the actuator element reaching the brake disks is ascertained depending on an operating current of the electric motor and/or on data of the speed sensor. For example, as the actuator element impinges on the brake disk, the operating current increases abruptly so that the impingement is deduced as soon as the operating current exceeds, for example, a specified limit value. Alternatively or additionally, the speed sensor is monitored and it is deduced that the actuator element has reached the brake disks as soon as it has been recognized that the number of previously sensed revolutions is no longer changing.

Furthermore, according to an example embodiment of the present invention, it is preferably provided that the actuator element reaching the end stop is ascertained depending on an operating current of the electric motor and/or depending on data of the speed sensor, in particular in the manner described above with respect to reaching the brake disk.

Furthermore, according to an example embodiment of the present invention, it is preferably provided that an absolute movement path of the actuator element is ascertained and stored depending on the number of revolutions, and that the wear value is ascertained depending on the movement path or a movement path change. Preferably, a current movement path is compared to a movement path ascertained at an earlier time, in order to recognize a movement path change. If a movement path change is recognized, a wear value change can be determined. Alternatively, the wear value of the wheel brake unit is ascertained directly depending, for example, on an expected movement path, preferably depending on the sensed movement path.

According to an example embodiment of the present invention, particularly preferably, the method is carried out at regular intervals, in particular after each start of operation of a motor vehicle comprising the wheel brake unit, after a brake pad replacement and/or brake disk replacement. A wear value change can thus be determined promptly. A brake pad and/or brake disk replacement is also automatically recognizable by sensing the absolute movement path if, for example, the sensed path does not become larger but smaller. In previous methods, such a replacement cannot be automatically detected due to the relative path measurement used there. Rather, in the related art, a brake pad replacement or brake disk replacement must be actively entered into the software of the control unit by a user.

A device according to an example embodiment of the present invention includes a control unit that is specifically configured to perform the method according to the present invention when used as intended. This results in the aforementioned advantages.

The wheel brake unit according to an example embodiment of the present invention includes the aforementioned device of the present invention. This results in the aforementioned advantages.

The brake system according to an example embodiment of the present invention includes at least one wheel brake unit according to the present invention and at least one device according to the present invention. Optionally, the brake system comprises multiple electromechanical wheel brake units, which are configured like the one described above, and which are in particular operated by a common device according to the present invention.

Further advantages and preferred features and feature combinations result in particular from what is disclosed herein. The present invention will be explained in more detail below with reference to the figures.

### BRIEF DESCRIPTION OF THE DRAWINGS

FIG. 1 shows an advantageous brake system for a motor vehicle in a simplified illustration.

FIG. 2 a flow chart for explaining an advantageous method according to an example embodiment of the present invention.

### DETAILED DESCRIPTION OF EXAMPLE EMBODIMENTS

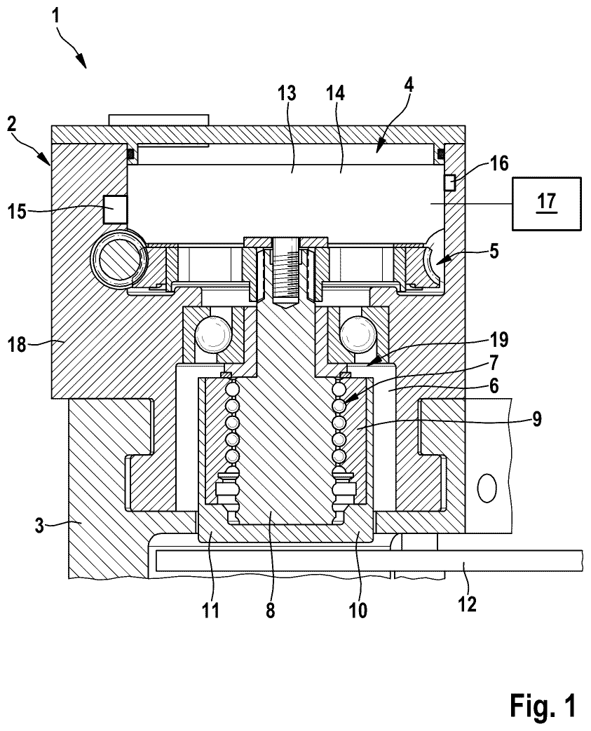

FIG. 1 shows, in a simplified sectional view, a brake system 1 for a motor vehicle (not shown in more detail here). The brake system 1 comprises an electromechanical wheel brake unit 2, which is assigned to a wheel of the motor vehicle. The wheel brake unit comprises a brake caliper 3. The brake caliper 3 supports a controllable actuator 4, which is connected by a transmission 5 to an actuator element 6 in such a way that the actuator element 6 is linearly movable. To this end, the transmission 5 according to the present exemplary embodiment comprises a spindle drive 7, with a spindle shaft that is drivable by the actuator 4 and on which a spindle nut 9 is arranged in a rotationally fixed manner with respect to the brake caliper 3 so that the spindle motor 9 is moved longitudinally by rotation of the spindle shaft 8. The transmission 5 is in particular a ball screw mechanism or linear converter. The spindle nut 9 is coupled to the actuator element 6, which in the present case is formed as a pressure piston 10 and has a brake pad 11 on its front face. The brake pad 11 is opposite to a brake disk 12 (only indicated here) of the wheel brake unit 2, wherein the brake disk 12 is preferably encompassed on both sides by the brake caliper 3 so that a further brake pad is present on the side of the brake disk 12 that faces away from the actuator element 6. The actuator 4 is designed as an electric motor 13, which comprises a rotatably mounted rotor 14, which is connected to the spindle shaft 8 by the transmission 5. Alternatively (not shown here), the rotor 14 is directly connected to the spindle shaft 8 in a rotationally fixed manner. In the present case, the rotor 14 is also assigned a speed sensor 5 and a current sensor 16.

The brake system 1 according to the present invention furthermore comprises a control unit 17, which is connected to the actuator 4 for the control thereof and also records the speed signals output by the speed sensor 5.

The actuator 4 comprises a housing 18, in which the actuator element 6 is substantially located and guided. On the side of the actuator element 6 that faces away from the brake disk 12, the housing 18 comprises a stop 19, to which the actuator element 6 can at most be pulled back or away from the brake disk 12. The stop 19 is thus so far away from the brake disk 12 that the actuator element 6 can be pulled further back to the stop 19 than would be necessary for adjusting an air gap between the pad 11 and the brake disk 12.

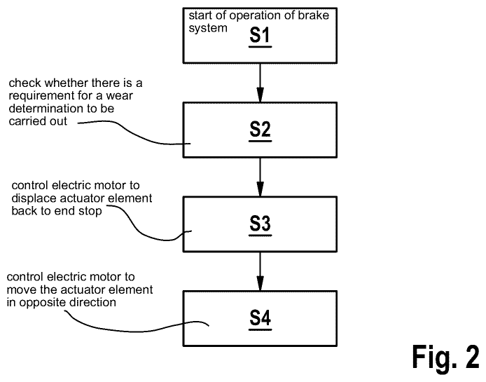

With reference to FIG. 2, an advantageous method for ascertaining a wear value of the wheel brake unit 2 is described below, which method is performed by the control unit 17 when used as intended.

The method begins in a step S1 with the start of operation of the brake system 1. In a following step S2, it is checked whether there is a requirement for a wear determination to be carried out. The existence of the requirement is in particular assumed if a predetermined amount of time has elapsed since the last wear determination, and/or if the brake system 1 has been put into operation so that the method is carried out with each start of operation of the brake system 1.

If the requirement is detected as fulfilled in step S2, the electric motor 13 is controlled in the following step S3 to displace the actuator element 6 back to the end stop 19. As a result, the actuator element 6 arrives at a defined home position or start position for carrying out the wear determination. Reaching the end stop is sensed, for example, in that the speed sensor does not sense another revolution of the rotor 14 and/or in that the current sensor 16 determines an increase in operating current above a specified limit value.

In a following step S4, the electric motor 14 is controlled to move the actuator element 6 in the opposite direction, i.e., toward the brake disk 12, until the actuator element 6 impinges with the brake pad 11 on the brake disk 12 so that a braking force or deceleration torque of the brake disk 12 is exerted. The actuator element 6 reaching the brake disk 12 is in particular sensed, as described above for the end stop 19, by monitoring the speed and/or the operating current of the electric motor 13. Until the brake disk 12 is reached, the number of revolutions of the rotor 13 is sensed by the speed sensor 15 and stored by the control unit 17. Depending on the number of revolutions, the wear or a wear value of the wheel brake unit 2 is ascertained. If the number of revolutions changes, for example with a wear determination carried out again later, it is recognized that the wear of wheel brake unit 2 has changed or increased. By moving the actuator element 6 from the end stop 19 toward the brake disk 12, an absolute wear value of the wheel brake unit 2 can be determined. Depending on the number of revolutions, the movement path of the actuator element 6 is ascertained. If the movement path increases, the wear value of the wheel brake unit 2 has increased. This ensures safe monitoring of the wear state of the wheel brake unit 2. If the ascertained wear value exceeds, for example, a specified limit value, a warning is output to the driver of the motor vehicle.

What is claimed is:

1. A method for ascertaining a wear value of an electromechanical wheel brake unit for a motor vehicle, the wheel brake unit including a displaceable actuator element, which is movable by a controllable actuator against a brake disk of the wheel brake unit to generate a braking force, and the actuator including an electric motor with a rotor rotatably mounted and operatively connected to the actuator element, the method comprising:
ascertaining, depending on the displacement of the actuator element, the wear value of the wheel brake unit, wherein, for ascertaining the wear value, the actuator element is first displaced against an end stop, the actuator element is subsequently moved against the brake disk, and, when the actuator element is moved from the end stop against the brake disk, a number of revolutions of the rotor is monitored and, depending on the sensed number of revolutions, the wear value of the wheel brake unit is ascertained.

2. The method according to claim 1, wherein a speed sensor is assigned to the rotor, and the number of revolutions is sensed using the speed sensor.

3. The method according to claim 1, wherein the actuator element reaching the brake disk is ascertained depending: (i) on an operating current of the electric motor, and/or (ii) on data of the speed sensor.

4. The method according to claim 1, wherein the actuator element reaching the end stop is ascertained depending: (i) on an operating current of the electric motor, and/or (ii) on data of the speed sensor.

5. The method according to claim 1, wherein, depending on the number of revolutions, an absolute movement path of the actuator element is ascertained and stored, and, depending on the absolute movement path or a movement path change, the wear value is ascertained.

6. The method according to claim 1, wherein the method is carried out at regular intervals including after each start of operation of a motor vehicle including the wheel brake unit.

7. A device for operating an electromechanical wheel brake unit of a motor vehicle, wherein the wheel brake unit includes a displaceable actuator element which is movable by a controllable actuator against a brake disk of the wheel brake unit to generate a braking force, wherein the actuator includes an electric motor with a rotor rotatably mounted and operatively connected to the actuator element, the device comprising:
a control unit specifically configured to ascertain, depending on the displacement of the actuator element, a wear value of the wheel brake unit, wherein, for ascertaining the wear value, the actuator element is first displaced against an end stop, the actuator element is subsequently moved against the brake disk, and, when the actuator element is moved from the end stop against the brake disk, a number of revolutions of the rotor is monitored and, depending on the sensed number of revolutions, the wear value of the wheel brake unit is ascertained.

8. An electromechanical wheel brake unit, comprising:
a displaceable actuator element which is movable by a controllable actuator against a brake disk of the wheel brake unit to generate a braking force, the actuator including an electric motor with a rotor rotatably mounted and operatively connected to the actuator element; and
a device for operating an electromechanical wheel brake unit, the device including:
a control unit specifically configured to ascertain, depending on the displacement of the actuator element, a wear value of the wheel brake unit, wherein, for ascertaining the wear value, the actuator element is first displaced against an end stop, the actuator element is subsequently moved against the brake disk, and, when the actuator element is moved from the end stop against the brake disk, a number of revolutions of the rotor is monitored and, depending on the sensed number of revolutions, the wear value of the wheel brake unit is ascertained.

9. A brake system for a motor vehicle, the brake system comprising:
one or more electromechanical wheel brake units, each including:
a displaceable actuator element which is movable by a controllable actuator against a brake disk of the wheel brake unit to generate a braking force, the actuator including an electric motor with a rotor rotatably mounted and operatively connected to the actuator element; and
a device for operating an electromechanical wheel brake unit, the device including:
a control unit specifically configured to ascertain, depending on the displacement of the actuator element, a wear value of the wheel brake unit, wherein, for ascertaining the wear value, the actuator element is first displaced against an end stop, the actuator element is subsequently moved against the brake disk, and, when the actuator element is moved from the end stop against the brake disk, a number of revolutions of the rotor is monitored and, depending on the sensed number of revolutions, the wear value of the wheel brake unit is ascertained.
